(19) United States
(12) Patent Application Publication
(10) Pub. No.: US 2025/0010233 A1
(43) Pub. Date: Jan. 9, 2025

(54) FILTER AND AIR PURIFIER

(71) Applicant: Membrane solutions (Nantong) Co., Ltd., Nantong (CN)

(72) Inventors: Teng CHEN, Nantong (CN); Longhai WANG, Nantong (CN)

(73) Assignee: Membrane solutions (Nantong) Co., Ltd., Nantong (CN)

(21) Appl. No.: 18/754,186

(22) Filed: Jun. 26, 2024

(30) Foreign Application Priority Data
Jul. 4, 2023 (CN) 202321739930.X

(51) Int. Cl. B01D 46/00

(52) U.S. Cl. CPC B01D 46/0005; B01D 2265/024; B01D 2271/02

(57) ABSTRACT

The present application relates to the technical field of filter structure, and in particular to a filter and an air purifier. The filter is for installation in a mounting frame. The filter includes a filter body. A positioning groove is provided on a side of the filter body facing toward the mounting frame. A positioning protrusion is provided in the mounting frame. The positioning protrusion and the positioning groove are configured to correspond to each other and cooperate with each other. When the filter body is installed in the mounting frame, the positioning protrusion enters the positioning groove.

### CROSS REFERENCE TO RELATED APPLICATION

This application claims the benefit of and priority from Chinese Patent Application No. 202321739930X, filed Jul. 4, 2023, the entire disclosure of which is incorporated herein by reference for all purposes.

### TECHNICAL FIELD

The present application relates to the technical field of filter structures, and in particular to filters and air purifiers.

### BACKGROUND

With the development of society and the improvement of people's quality of life, air purifiers can be seen on more and more occasions. Air purifiers can effectively filter, adsorb, and decompose various pollutants in the air to ensure people's breathing health. The existing filter of the purifier primarily features a flat or barrel-shaped symmetrical structure.

### SUMMARY

In an aspect, the present application provides a filter. The filter is to be installed in a mounting frame when in use. The filter includes a filter body; a positioning groove is provided on a side of the filter body facing toward the mounting frame; a positioning protrusion is provided in the mounting frame; the positioning protrusion and the positioning groove are configured to correspond to and cooperate with each other; and when the filter body is installed in the mounting frame, the positioning protrusion enters the positioning groove.

In some embodiments, a signal element is provided on the filter body, and a detection element for cooperating with the signal element is provided on the mounting frame.

In some embodiments, a sealing member is provided between an inner side wall of the mounting frame and an outer side wall of the filter body.

In some embodiments, a sealing groove is provided in an outer peripheral side wall of the filter body, and a sealing member for sealing between the inner side wall of the mounting frame and the outer peripheral side wall of the filter body is provided in the sealing groove.

In some embodiments, multiple positioning grooves are provided on the side of the filter body facing toward the mounting frame, the multiple positioning grooves are arranged along a width direction of the filter body, multiple positioning protrusions are provided in the mounting frame, the multiple positioning protrusions are arranged along a width direction of the mounting frame, and the multiple positioning grooves are provided in a one-to-one correspondence with the multiple positioning protrusions.

In some embodiments, the signal element is arranged on the filter body, the detection element is arranged on the mounting frame, and the signal element and the detection element are arranged correspondingly.

In some embodiments, multiple signal elements are provided on the filter body, the multiple signal elements are arranged along the length direction or width direction of the filter body, multiple detection elements are provided on the mounting frame, the multiple detection elements are arranged along the length direction of the mounting frame, and the multiple signal elements are provided in a one-to-one correspondence with the multiple detection elements.

In some embodiments, the signal element includes a magnetic medium, and the detection element includes a Hall sensor that cooperates with the magnetic medium; or the signal element includes a metal medium, and the detection element includes a metal detection sensor that cooperates with the metal medium.

In some embodiments, a first engaging portion is provided on a side of the positioning protrusion, a second engaging portion is provided on a side wall of the positioning groove, the first engaging portion and the second engaging portion are configured to cooperate with each other, and when the filter body is installed in the mounting frame, the first engaging portion and the second engaging portion engage with each other.

In some embodiments, the first engaging portion includes a first stopper, the second engaging portion includes a second stopper, and when the filter body is installed in the mounting frame, a side of the first stopper facing away from the filter body abuts against a side of the second stopper facing away from the mounting frame.

In some embodiments, an end of the first stopper facing an interior of the mounting frame is a first inclined surface, an end of the second stopper facing away from the filter body is a second inclined surface, and the first inclined surface is configured to cooperate with the second inclined surface.

In some embodiments, the second engaging portion includes two second stoppers, and the two second stoppers are respectively arranged on two opposite inner side walls of the positioning groove.

In some embodiments, the filter body includes a particle filter and an odor adsorber that are provided in a stacked manner.

In some embodiments, the particle filter portion is a hydrophobic particle filter, and the odor adsorber is a hydrophobic odor adsorber.

In some embodiments, the particle filter portion is folded into a pleated shape.

In some embodiments, the filter body further includes a housing and a cover, the housing and the cover are configured to be arranged opposite to each other and cooperate with each other, and the particle filter and the odor adsorber are configured to be arranged between the housing and the cover.

In some embodiments, a gap is formed between a first side of the cover and a second side of the housing, wherein the first side is opposite to the second side, and the sealing member is arranged on the outer peripheral side wall of the filter body and is used to close the gap.

In some embodiments, a support grid is provided on a side of the cover facing away from the housing.

In some embodiments, a first fastener is provided on the housing, a second fastener is provided on the cover, and the first fastener is configured to cooperate with the second fastener to lock the housing and the cover.

In some embodiments, the filter body further includes a dustproof net, which is arranged on a side of the particle filter away from the odor adsorber or on a side of the odor adsorber away from the particle filter.

In another aspect, the present application also provides an air purifier including the filter as described above.

### BRIEF DESCRIPTION OF DRAWINGS

FIG. 1 is a schematic diagram of the cooperation between a filter body and a mounting frame according to exemplary embodiments of the present application.

FIG. 2 is a schematic diagram of the structure of a filter body according to exemplary embodiments of the present application.

FIG. 3 is a partially enlarged view of point A in FIG. 2 according to exemplary embodiments of the present application.

FIG. 4 is a schematic diagram of the structure of a mounting frame according to exemplary embodiments of the present application.

FIG. 5 is a partially enlarged view of point B in FIG. 4 according to exemplary embodiments of the present application.

FIG. 6 is a partial cross-sectional view of a filter body installed on a mounting frame according to exemplary embodiments of the present application.

FIG. 7 is a schematic diagram of the structure of a mounting frame according to exemplary embodiments of the present application.

FIG. 8 is a partially enlarged view of point C in FIG. 7 according to exemplary embodiments of the present application.

FIG. 9 is a schematic diagram of the structure of a filter body according to exemplary embodiments of the present application.

FIG. 10 is a partially enlarged view of point D in FIG. 9 according to exemplary embodiments of the present application.

FIG. 11 is an exploded view of a filter body according to exemplary embodiments of the present application.

FIG. 12 is a schematic diagram of the structure of a particle filter according to exemplary embodiments of the present application.

### DESCRIPTION OF REFERENCE NUMBERS

1-filter body; 11-positioning groove; 12-signal element; 13-sealing groove; 14-sealing member; 15-second stopper; 151-second inclined surface; 152-processed groove; 16-particle filter; 17-odor adsorber; 18-housing; 181-first engaging portion; 182-signal element slot; 19-cover; 192-support grid; 193-second engaging portion; 2-mounting frame; 21-positioning protrusion; 22-receiving chamber; 23-detection element; 24-first stopper; 241-first inclined surface.

### DESCRIPTION OF EMBODIMENTS

The following describes embodiments of the present application through specific examples. Those skilled in the art can easily understand other advantages and effects of the present application from the contents disclosed in this specification. The present application can also be implemented or applied through other different specific embodiments. The details in this specification can also be modified or changed in various ways based on different viewpoints and applications without departing from the spirit of the present application.

It should be noted that the diagrams provided in the present embodiment are only used to illustrate the basic concept of the present application in a schematic manner, so the diagrams only show the components related to the present application and are not drawn according to the number, shape, and dimension of the components during actual implementation. The type, quantity, and scale of each component during actual implementation can be changed at will, and the layout type of the component may also be more complicated. The structure, scale, size, etc. shown in the drawings attached to this specification are only used to match the content disclosed in the specification for people familiar with this technology to understand and read, and are not used to limit the limiting conditions that the present application can be implemented, so they have no technical substantive significance. Any modification to the structure, change in the proportional relationship, or adjustment of the dimension should still fall within the scope of the technical content disclosed by the present application without affecting the effect and purpose that the present application can produce. Meanwhile, the terms such as “upper”, “lower”, “left”, “right”, “middle”, and “one” quoted in this specification are only for the convenience of narration, and are not used to limit the scope of the present application. Any change or adjustment of the relative relationship without substantial change of the technical content should also be regarded as fallen into the scope of the present application.

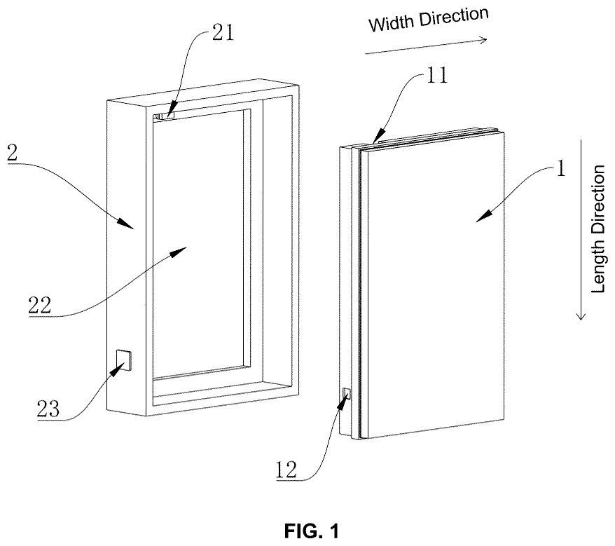

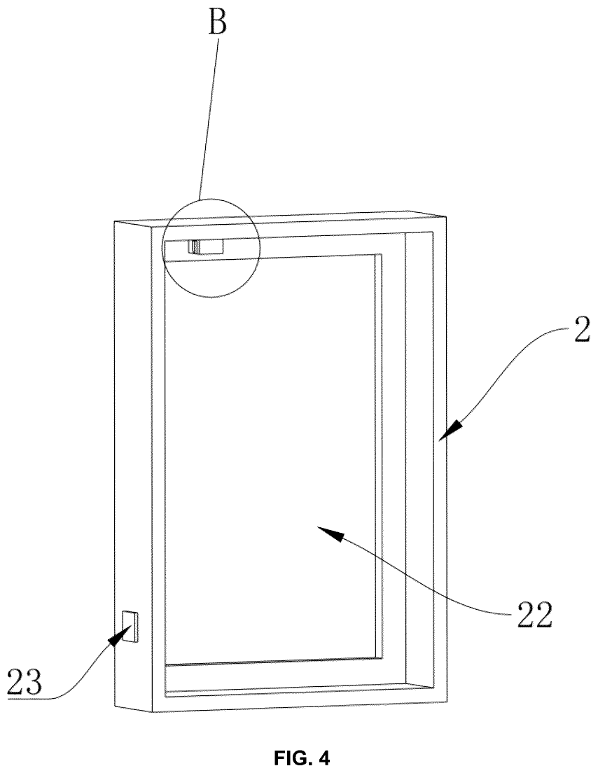

Please refer to FIGS. 1, 2 and 4. One or more embodiments provide a filter. The filter is installed in a mounting frame 2 when in use. The filter includes a filter body 1. The mounting frame 2 has a receiving chamber 22. The filter body 1 is arranged opposite to the receiving chamber 22. The filter body 1 is installed in the receiving chamber 22. A positioning protrusion 21 is provided in the receiving chamber 22 of the mounting frame 2. A positioning groove 11 is provided on the side of the filter body 1 facing the mounting frame 2. The position where the positioning protrusion 21 is located on the mounting frame 2 corresponds to the position where the positioning groove 11 is created on the filter body 1. The positioning protrusion 21 and the filter body 1 can cooperate with each other. When the filter body 1 is installed in the receiving chamber 22 of the mounting frame 2, the positioning protrusion 21 enters the positioning groove 11. In some embodiments, this prevents the filter body 1 from being installed incorrectly on the front and back sides in the air purifier, thereby preventing the filtering effect of the air purifier from being affected.

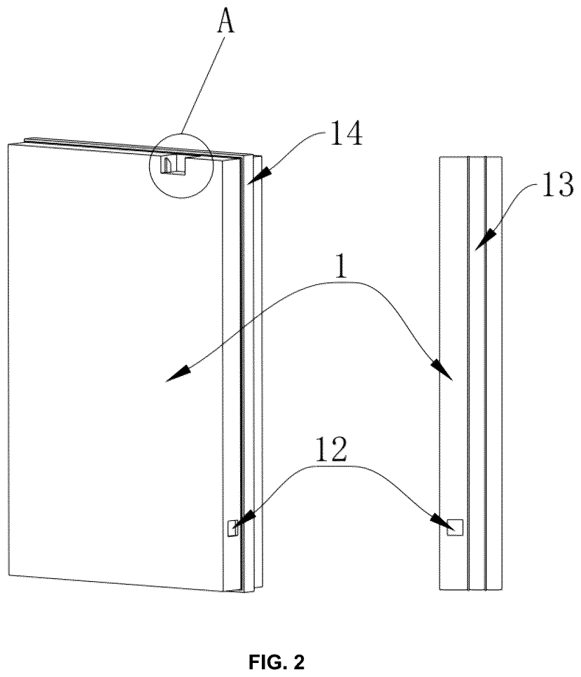

In one or more embodiments, as shown in FIG. 2, a signal element 12 is provided on the filter body 1. The signal element 12 can be provided at any position of the filter body 1. A detection element 23 for cooperating with the signal element 12 is provided on the mounting frame 2. The detection element 23 is configured to detect the signal element 12. The detection element 23 can be provided at any position of the mounting frame 2. The signal element 12 and the detection element 23 are provided correspondingly to each other. When the filter body 1 is installed in place in the receiving chamber 22, the detection element 23 can detect the signal element 12. The detection element 23 is configured to detect the signal element 12 to monitor whether the filter body 1 is installed in place in the mounting frame 2. In some embodiments, this prevents the filter body 1 from falling off during use and affecting the filtering effect.

In one or more embodiments, the signal element 12 is provided in the positioning groove 11, and the detection element 23 is provided on the positioning protrusion 21.

In one or more embodiments, a sealing member 14 is provided between an inner side wall of the mounting frame 2 and an outer peripheral side wall of the filter body 1. When the filter body 1 is installed in the receiving chamber 22 of the mounting frame 2, the sealing member 14 provides a seal between the inner side wall of the mounting frame 2 and the outer peripheral side wall of the filter body 1. In some embodiments, this improves the filtering effect.

In one or more embodiments, as shown in FIG. 2, a sealing groove 13 is created on the outer peripheral side wall of the filter body 1 along the circumference of the filter body 1, and a sealing member 14 is provided in the sealing groove 13. When the filter body 1 is installed in the receiving chamber 22 of the mounting frame 2, the sealing member 14 provides a seal between the inner side wall of the mounting frame 2 and the outer peripheral side wall of the filter body 1. In some embodiments, this improves the filtering effect.

In one or more embodiments, there are multiple positioning grooves 11 arranged along the width direction of the filter body 1, and there are multiple positioning protrusions 21 arranged along the width direction of the mounting frame 2. The positioning grooves 11 and the positioning protrusions 21 are provided in one-to-one correspondence and cooperate mutually to form a more stable positioning and fixing structure.

In one or more embodiments, as shown in FIG. 1, the signal element 12 is a magnetic medium, such as neodymium iron boron, iron, copper, nickel, and alloys thereof, and the detection element 23 is a Hall sensor that cooperates with the signal element 12. In one or more embodiments, the signal element 12 is a metal medium, and the detection element 23 is a metal detection sensor that cooperates with the signal element 12. In one or more embodiments, the signal element 12 is provided on the outer peripheral side wall of the filter body 1, and the detection element 23 is correspondingly provided on the outer peripheral side wall of the mounting frame 2.

In one or more embodiments, there are multiple signal elements 12, and the multiple signal elements 12 are arranged along the length direction or width direction of the filter body 1. In one or more embodiments, the multiple signal elements 12 are provided on the long side of the filter body 1 and arranged along the length direction of the filter body 1. In one or more embodiments, the multiple signal elements 12 are provided on the short side of the filter body 1. For example, the multiple signal elements 12 are provided on the short side opposite to the positioning protrusion 21, and arranged along the width direction of the filter body 1. In one or more embodiments, there are multiple detection elements 23, and the multiple detection elements 23 are arranged along the length direction of the mounting frame 2. The signal elements 12 are provided in a one-to-one correspondence with the detection element 23.

In one or more embodiments, a first engaging portion is provided on the side of the positioning protrusion 21, and a second engaging portion is provided on the inner side wall of the positioning groove 11. The first engaging portion and the second engaging portion are configured to cooperate with each other. When the filter body 1 is installed in the mounting frame 2, the first engaging portion engages with the second engaging portion. In one or more embodiments, by engaging the first engaging portion with the second engaging portion, the filter body 1 can be more firmly installed in the mounting frame 2.

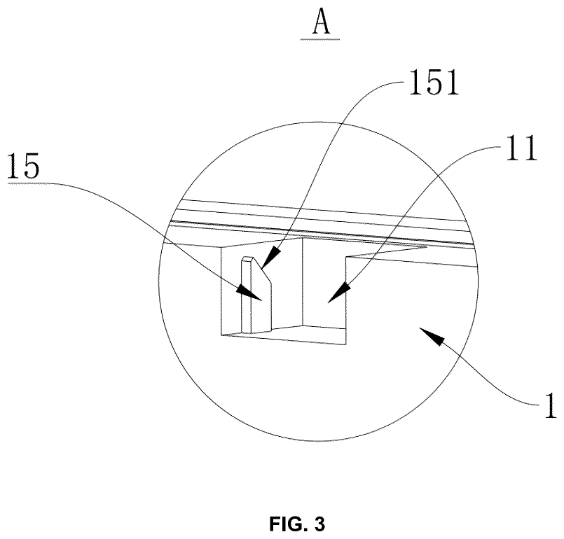

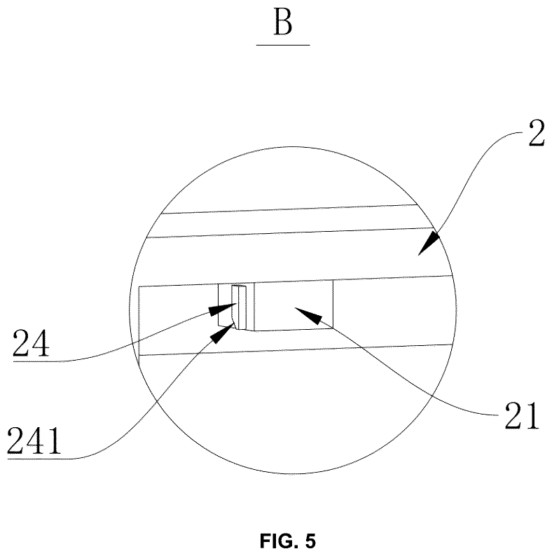

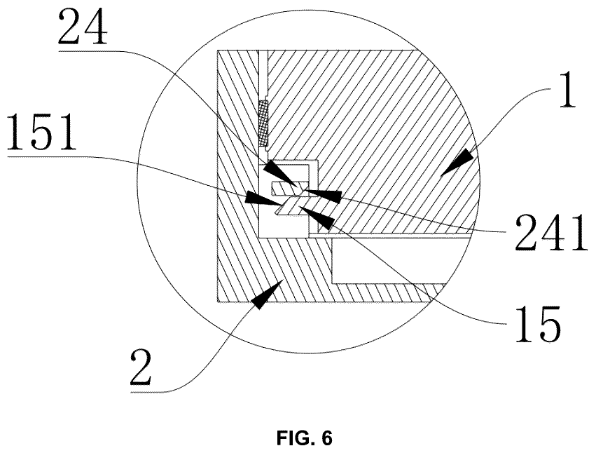

In one or more embodiments, as shown in FIGS. 3, 5, and 6, the first engaging portion includes a first stopper 24, and the second engaging portion includes a second stopper 15. When the filter body 1 is installed in the mounting frame 2, the side of the first stopper 24 facing away from the filter body 1 abuts against the side of the second stopper 15 facing away from the mounting frame 2. When the filter body 1 is installed, one end of the filter body 1 provided with the second stopper 15 is first installed in the mounting frame 2, and the filter body 1 is installed obliquely downward, so that the second stopper 15 snaps into the rear of the first stopper 24. Then the other end of the filter body 1 is installed. Finally, the side of the first stopper 24 facing away from the filter body 1 abuts against the side of the second stopper 15 facing away from the mounting frame 2 to engage the first stopper 24 with the second stopper 15.

In one or more embodiments, as shown in FIGS. 3, 5, and 6, the bottom end of the first stopper 24 is a first inclined surface 241 that is higher outside and lower inside, and the second stopper 15 is a second inclined surface 151 that is higher inside and lower outside. The first inclined surface 241 is configured to cooperate with the second inclined surface 151. In one or more embodiments, this facilitates the second stopper 15 to snap into the rear of the first stopper 24.

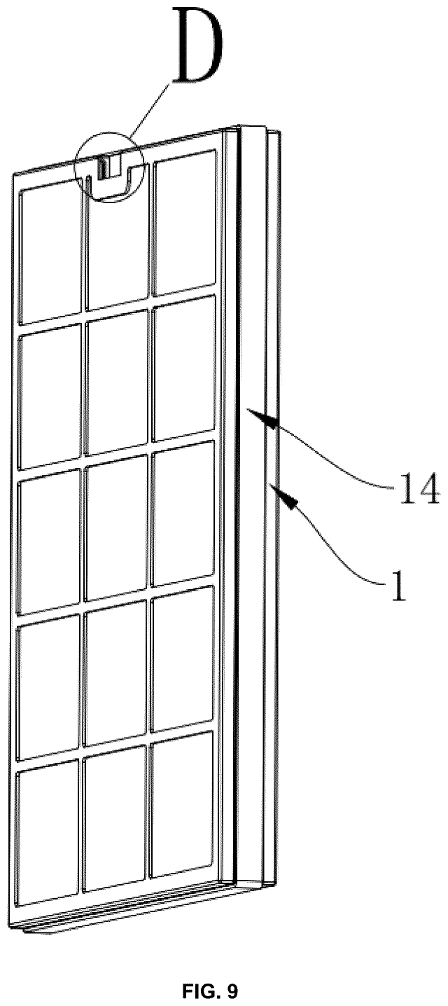

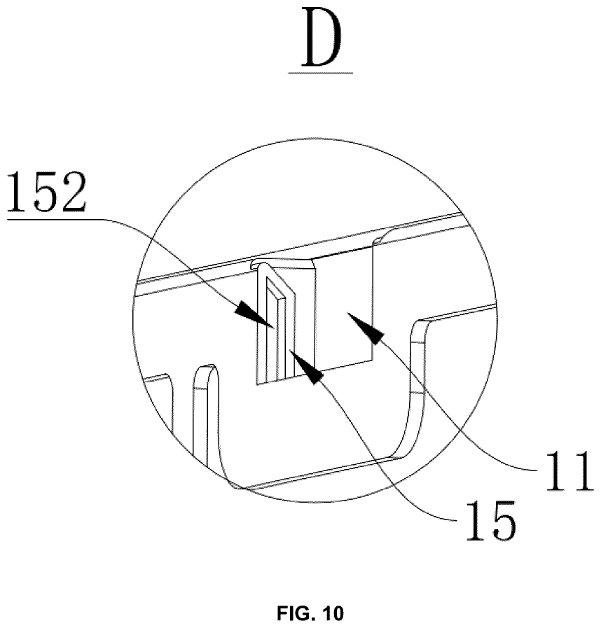

In one or more embodiments, as shown in FIG. 9 and FIG. 10, there are two second stoppers 15, which are respectively provided on the inner walls of two opposite sides of the positioning groove 11. A first processed groove 152 is provided on a first side of one of the two second stoppers 15, and a second processed groove 152 is provided on a second side of the other of the two second stoppers 15, where the second side is opposite to the first side. The depth of the process groove 152 is equal to the thickness of the second stopper 15. In one or more embodiments, the provision of the process groove 152 avoids some surface defects caused by the excessive wall thickness of the second stopper 15 during injection molding, thereby improving the product yield.

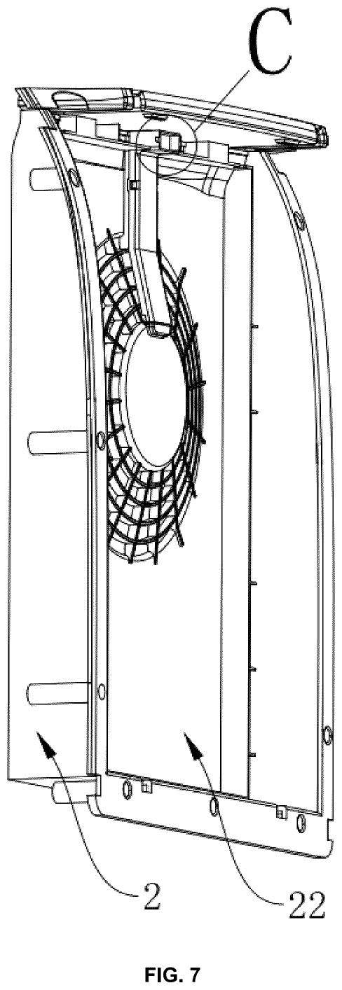

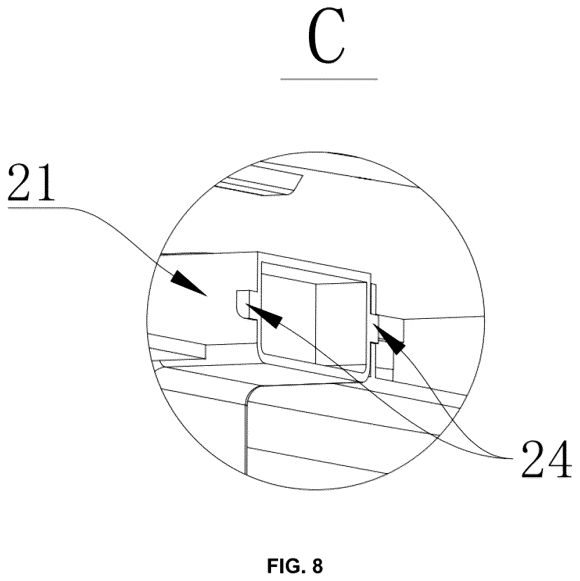

In one or more embodiments, as shown in FIG. 7 and FIG. 8, the positioning protrusion 21 opens on the side facing toward the filter body 1. In one or more embodiments, this reduces the weight of the mounting frame 2 and facilitates the installation between the filter body 1 and the mounting frame 2.

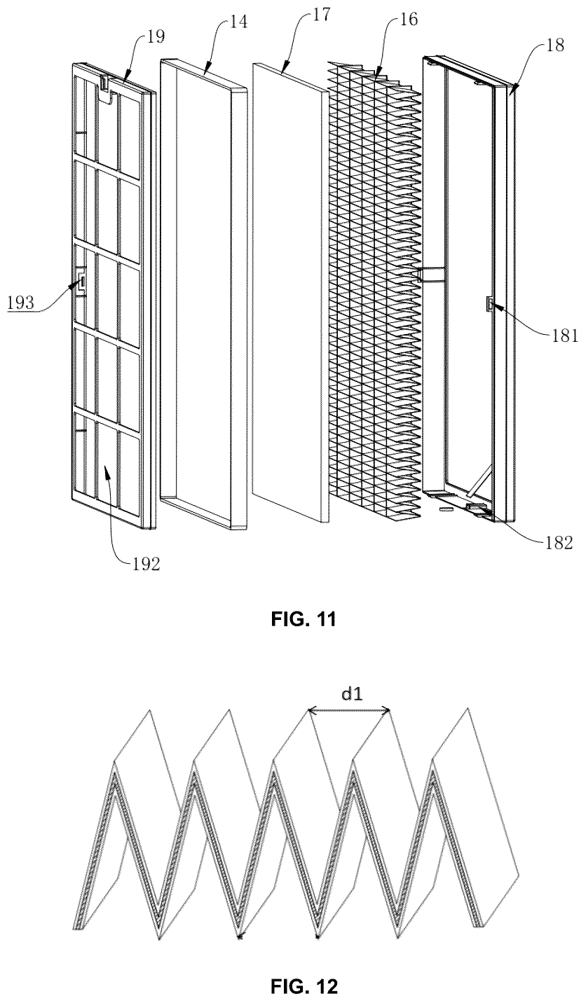

In one or more embodiments, as shown in FIG. 11, the filter body 1 includes a particle filter 16 and an odor adsorber 17 which are provided in a stacked manner. In one or more embodiments, there are one or more layers of particle filters 16 and one or more layers of odor adsorbers 17. In one or more embodiments, when there is more than one layer of particle filter 16 and odor adsorber 17, the particle filters 16 and the odor adsorbers 17 are alternately arranged. In one or more embodiments, the air intake side of the filter body 1 is provided with a particle filter 16 or an odor adsorber 17. The particle filter 16 is configured to filter particles, and the odor adsorber 17 is configured to adsorb odors in the air. In one or more embodiments, the filter body 1 not only filters particles in the air, but also adsorbs odors in the air, playing the role of multiple filtrations and improving the air filtering effect and user experience.

In one or more embodiments, as shown in FIG. 12, the particle filter 16 is folded into a shape with undulating pleats. In one or more embodiments, this increases the expanded area of the particle filter 16 to increase the filtering area of the filter, thereby improving the overall filtering effect of the filter. The size of the pleat spacing d1 (i.e., the distance between adjacent pleats) will affect the performance of the filter. If the spacing is too small, the air resistance is large, and the adsorption effect is poor. If the spacing is too large, the contact area with the air is small, the adsorption effect is also poor, and the air purifier generates noise.

In one or more embodiments, the odor adsorber 17 is folded into a pleated shape. In one or more embodiments, this increases the expanded area of the odor adsorber 17 to increase the filtering area of the filter, thereby improving the overall filtering effect of the filter.

In one or more embodiments, the particle filter 16 is a hydrophobic particle filter, and the odor adsorber 17 is a hydrophobic odor adsorber. Since the hydrophobic particle filter and the hydrophobic odor adsorber can be washed with water, their performance is almost not attenuated after washing. Therefore, since the entire filter body 1 can be washed with water, its performance is almost not attenuated after washing. Thus, it can be reused, thereby extending the life of the filter.

In one or more embodiments, the hydrophobic odor adsorber includes a hydrophobic base layer and a hydrophobic adsorption layer adhered to the hydrophobic base layer. As to the materials of the hydrophobic base layer and the hydrophobic adsorption layer, the hydrophobic adsorption layer can be hydrophobically treated with a deodorizing modifier, and the deodorizing modifier is also a conventional technique. In one or more embodiments, the deodorizing modifier includes, by mass percentage: 5%-10% of odor active treatment component, 2%-4% of hydrophobic modifier, 0.5%-2% of hydrophobic modifying additive, 85%-92% of water, and 0.5%-1% of pH adjuster. In one or more embodiments, the deodorizing active component of the hydrophobic odor adsorber after treatment is protected in the water environment, thereby maintaining high activity and stability, so that the hydrophobic odor adsorber is hydrophobic and can be washed with water, and the performance is almost not attenuated after washing with water.

In one or more embodiments, the hydrophobic particle filter includes at least two of a polyester or polyethylene non-woven fabric protective layer, a polymer nanofiber layer, and a polyester or polyethylene non-woven fabric substrate layer. The layers of the hydrophobic particle filter are provided in a stacked manner. In one or more embodiments, the hydrophobic particle filter includes a polyester or polyethylene non-woven fabric protective layer and a polymer nanofiber layer that are stacked in sequence along the airflow direction. In one or more embodiments, the hydrophobic particle filter includes a polyester or polyethylene non-woven fabric protective layer, a polymer nanofiber layer, and a polyester or polyethylene non-woven fabric substrate layer that are stacked in sequence along the airflow direction. In one or more embodiments, the hydrophobic particle filter includes a polymer nanofiber layer and a polyester or polyethylene non-woven fabric substrate layer that are stacked in sequence along the airflow direction. In one or more embodiments, the hydrophobic particle filter includes a polyester or polyethylene non-woven fabric protective layer, a polymer nanofiber layer, and a polyester or polyethylene non-woven fabric substrate layer which are sequentially stacked along the airflow direction, that is, the hydrophobic particle filter includes a polyester or polyethylene non-woven fabric protective layer, a polymer nanofiber layer, and a polyester or polyethylene non-woven fabric substrate layer which are sequentially stacked from inside to outside. In one or more embodiments, the layers of the hydrophobic particle filter are compounded by thermal bonding or by spraying or coating with hot-melt glue.

In one or more embodiments, the polyester or polyethylene non-woven fabric protective layer includes a layer of hydrophobic polyester non-woven fabric or hydrophobic polyethylene non-woven fabric. The polymer nanofiber layer is a layer of nanofiber that is formed by compositing polymer on polyester fabric through hot melt stretching or electrostatic spinning process. The polyester or polyethylene non-woven fabric substrate layer includes a layer of non-woven polyester (PET) or polyethylene (PE).

In one or more embodiments, a hydrophobic odor adsorption layer includes any one or more mesoporous materials selected from activated carbon, molecular sieve, zeolite, and diatom mud. The modified activated carbon particles are bonded with a binder or coated by an impregnation process to ensure that the activated carbon particles are evenly distributed on the hydrophobic base layer to form a hydrophobic odor adsorber. The shape of the mesh of the hydrophobic base layer can be a quadrilateral, hexagonal, circular, or irregular porous shape.

In one or more embodiments, as shown in FIG. 11, the filter body 1 further includes a housing 18 and a cover 19. The housing 18 and the cover 19 are provided opposite to each other, and a first side of the housing 18 abuts against a second side of the cover 19 which is opposite to the first side. In one or more embodiments, the housing 18 and the cover 19 are both rectangular and have equal cross-sectional dimensions. The particle filter 16 and the odor adsorber 17 are provided between the housing 18 and the cover 19. The particle filter 16 and the odor adsorber 17 are fixedly arranged between the housing 18 and the cover 19. In one or more embodiments, this avoids the particle filter 16 and the odor adsorber 17 from curling or other deformation during use, thereby improving the filtering effect and service life.

In one or more embodiments, as shown in FIG. 11, a visible or invisible gap is formed between a first side of the cover 19 and a second side of the housing 18 which is opposite to the first side. The sealing member 14 is provided on the outer peripheral side wall of the filter body 1 and is used to close the gap. In one or more embodiments, the cover 19, the housing 18, the particle filter 16, and the odor adsorber 17 are all rectangular. In one or more embodiments, the sealing member 14 is made of rubber material, is provided on the gap between the cover 19 and the housing 18, and seals the gap between the cover 19 and the housing 18 from the outside. In one or more embodiments, the provision of the sealing member 14 improves the sealing effect between the cover 19 and the housing 18. The first half of the sealing member 14 in the width direction is provided on the outer peripheral side wall of the cover 19, and the second half of the sealing member 14 is provided on the outer peripheral side wall of the housing 18. In one or more embodiments, this improves the fixing effect between the cover 19 and the housing 18.

In one or more embodiments, as shown in FIG. 11, a plurality of support grids 192 is provided on any side of the cover 19. In one or more embodiments, the support grids 192 are provided on the side of the cover 19 away from the housing 18. In one or more embodiments, this facilitates the arrangement and installation of the particle filter 16 and the odor adsorber 17 in the inner chamber of the housing 18. In one or more embodiments, the shape of the support grid 192 is rectangular, circular, triangular, diamond, or other polygonal shapes. In one or more embodiments, the support grid 192 improves the structural strength of the cover 19, thereby improving the structural strength of the filter body 1.

In one or more embodiments, as shown in FIG. 11, a first fastener 181 is provided on the housing 18, and a second fastener 193 is provided on the cover 19. The first fastener 181 is configured to cooperate with the second fastener 193 to lock the housing 18 and the cover 19 in a direction of approaching and moving away from each other. The first fastener 181 can be provided at any position of the housing 18, and the second fastener 193 can be provided at any position on the cover 19. The first fastener 181 and the second fastener 193 are provided correspondingly and configured to cooperate with each other. In one or more embodiments, the provision of the first fastener 181 and the second fastener 193 improves the connection stability between the cover 19 and the housing 18, and prevents the filtering effect of the filter body 1 from being affected due to the separation of the cover 19 and the housing 18 during use.

In one or more embodiments, the number of the first fasteners 181 and the number of the second fasteners 193 are equal and both are more than one. In one or more embodiments, the first fasteners 181 are distributed on each edge of the housing 18, and the second fasteners 193 are distributed on each edge of the cover 19.

In one or more embodiments, at least one first fastener 181 is provided on the side of each edge of the housing 18 facing toward the cover 19, and at least one second fastener 193 is provided on the side of each edge of the cover 19 facing toward the housing 18.

In one or more embodiments, as shown in FIG. 11, the housing 18 is provided with a signal element slot 182 for receiving the signal element 12. The signal element 12 is fixedly provided in the signal element slot 182. In one or more embodiments, this avoids the problem that the signal element 12 is easy to fall off during use. In one or more embodiments, the signal element slot 182 is provided on the inner side wall of the housing 18.

In one or more embodiments, the filter body 1 further includes a dustproof net. In one or more embodiments, the dustproof net is provided on the side of the particle filter 16 away from the odor adsorber 17. In one or more embodiments, the dustproof net is provided on the side of the odor adsorber 17 away from the particle filter 16. In one or more embodiments, the dustproof net is provided on the surface of the air intake side of the filter body 1. The surface of the air intake side of the filter body 1 can also be understood as the outer surface of the filter body 1. For example, the material of the dustproof net is selected from nylon, PP, PET, PE, etc.

In one or more embodiments, the particle filter 16 and the odor adsorber 17 are both planar or square. The pleat spacing of both sides of the particle filter 16 is substantially the same as the pleat spacing of both sides of the odor adsorber 17. In one or more embodiments, the pleat spacing on both sides of the particle filter 16 or the odor adsorber 17 is in the range of 2.5 mm-5.5 mm, so that the air filtering effect of the filter is better and the noise is smaller. After a huge number of experiments, in one or more embodiments, the air filtering effect of the filter is ideal and the noise is minimized when the pleat spacing on both sides of the particle filter 16 or the odor adsorber 17 is in the range of 3.0 mm-4.0 mm.

The present application also provides an air purifier, including the filter as above.

As stated above, in some embodiments, the filter of the present application has the following beneficial effects.

In some embodiments, the filter is to be installed in a mounting frame when in use; the filter includes a filter body; a positioning groove is provided on a side of the filter body facing toward the mounting frame; a positioning protrusion is provided in the mounting frame; the positioning protrusion and the positioning groove are correspondingly provided and cooperate with each other; and when the filter body is installed in the mounting frame, the positioning protrusion enters the positioning groove. In some embodiments, the positioning protrusion enters the positioning groove, thereby preventing the filter body from being installed incorrectly on the front and back sides in the air purifier. As a result, the filtering effect of the air purifier will not be affected.

In some embodiments, incorrect installation of the filter can be avoided such that the purification effect of the air purifier will not be affected by the incorrect installation.

The above embodiments are merely illustrative of the principles and effects of the present application, and are not intended to limit the present application. Anyone familiar with the technology may modify or change the above embodiments without violating the spirit and scope of the present application. Therefore, all equivalent modifications or changes made by a person of ordinary skill in the art without departing from the spirit and technical ideas disclosed by the present application should still be covered by the claims of the present application.

What is claimed is:

1. A filter for installation in a mounting frame, comprising:
a filter body, wherein
a positioning groove is provided on a side of the filter body facing toward the mounting frame;
a positioning protrusion is provided in the mounting frame;
the positioning protrusion and the positioning groove are configured to correspond to each other and cooperate with each other; and
when the filter body is installed in the mounting frame, the positioning protrusion enters the positioning groove.

2. The filter according to claim 1, wherein
a signal element is provided on the filter body; and
a detection element configured to cooperate with the signal element is provided on the mounting frame.

3. The filter according to claim 1, wherein
a sealing member is provided between an inner side wall of the mounting frame and an outer side wall of the filter body.

4. The filter according to claim 1, wherein
a sealing groove is provided in an outer peripheral side wall of the filter body; and
a sealing member configured to seal between an inner side wall of the mounting frame and the outer peripheral side wall of the filter body is provided in the sealing groove.

5. The filter according to claim 1, wherein
multiple positioning grooves are provided on the side of the filter body facing toward the mounting frame;
the multiple positioning grooves are arranged along a width direction of the filter body;
multiple positioning protrusions are provided in the mounting frame;
the multiple positioning protrusions are arranged along a width direction of the mounting frame; and
the multiple positioning grooves are provided in a one-to-one correspondence with the multiple positioning protrusions.

6. The filter according to claim 2, wherein
multiple signal elements are provided on the filter body,
the multiple signal elements are arranged along a length direction or a width direction of the filter body;
multiple detection elements are provided on the mounting frame;
the multiple detection elements are arranged along a length direction of the mounting frame; and
the multiple signal elements are provided in a one-to-one correspondence with the multiple detection elements.

7. The filter according to claim 2, wherein
the signal element comprises a magnetic medium, and the detection element comprises a Hall sensor that cooperates with the magnetic medium; or
the signal element comprises a metal medium, and the detection element comprises a metal detection sensor that cooperates with the metal medium.

8. The filter according to claim 1, wherein
a first engaging portion is provided on a side of the positioning protrusion;
a second engaging portion is provided on a side wall of the positioning groove;
the first engaging portion and the second engaging portion are configured to cooperate with each other; and
when the filter body is installed in the mounting frame, the first engaging portion and the second engaging portion engage with each other.

9. The filter according to claim 8, wherein
the first engaging portion comprises a first stopper;
the second engaging portion comprises a second stopper; and
when the filter body is installed in the mounting frame, a side of the first stopper facing away from the filter body abuts against a side of the second stopper facing away from the mounting frame.

10. The filter according to claim 9, wherein
an end of the first stopper facing an interior of the mounting frame is a first inclined surface;
an end of the second stopper facing away from the filter body is a second inclined surface; and
the first inclined surface is configured to cooperate with the second inclined surface.

11. The filter according to claim 9, wherein
the second engaging portion comprises two second stoppers; and
the two second stoppers are respectively arranged on two opposite inner side walls of the positioning groove.

12. The filter according to claim 3, wherein
the filter body comprises a particle filter and an odor adsorber; and
the particle filter and the odor adsorber are provided in a stacked manner.

13. The filter according to claim 12, wherein
the particle filter is hydrophobic; and
the odor adsorber is hydrophobic.

14. The filter according to claim 12, wherein
the particle filter is folded into a pleated shape.

15. The filter according to claim 12, wherein
the filter body further comprises a housing and a cover;
the housing and the cover are configured to be arranged oppositely and cooperate with each other; and
the particle filter and the odor adsorber are configured to be arranged between the housing and the cover.

16. The filter according to claim 15, wherein
a gap is formed between a first side of the cover and a second side of the housing, wherein the first side is opposite to the second side; and
the sealing member is arranged on an outer peripheral side wall of the filter body and is configured to close the gap.

17. The filter according to claim 15, wherein
a supporting grid is provided on a side of the cover facing away from the housing.

18. The filter according to claim 15, wherein
a first fastener is provided on the housing;
a second fastener is provided on the cover; and
the first fastener is configured to cooperate with the second fastener to lock the housing and the cover.

19. The filter according to claim 12, wherein
the filter body also comprises a dustproof net; and
the dustproof net is arranged on a side of the particle filter away from the odor adsorber or on a side of the odor adsorber away from the particle filter.

20. An air purifier, comprising a filter and a mounting frame for installing the filter, wherein
the filter comprises a filter body, wherein
a positioning groove is provided on a side of the filter body facing toward the mounting frame;
a positioning protrusion is provided in the mounting frame;
the positioning protrusion and the positioning groove are configured to correspond to each other and cooperate with each other; and
when the filter body is installed in the mounting frame, the positioning protrusion enters the positioning groove.
